(19) United States
(12) Patent Application Publication
(10) Pub. No.: US 2016/0216670 A1
(43) Pub. Date: Jul. 28, 2016

(54) IMAGE FORMING APPARATUS AND METHOD OF CONTROLLING SAME

(71) Applicant: CANON KABUSHIKI KAISHA, Tokyo (JP)

(72) Inventors: Hiroyuki Eda, Moriya-shi (JP); Naoto Watanabe, Abiko-shi (JP); Yuichi Yamamoto, Nagareyama-shi (JP); Hidenori Matsumoto, Kashiwa-shi (JP)

(21) Appl. No.: 14/996,690

(22) Filed: Jan. 15, 2016

(30) Foreign Application Priority Data
Jan. 22, 2015 (JP) 2015-010681

(51) Int. Cl. G03G 15/00; G06K 15/12; G06K 15/00

(52) U.S. Cl. CPC G03G 15/5012; G06K 15/4085; G06K 15/406; G06K 15/129

(57) ABSTRACT

In the present invention, an image forming apparatus, when executing a preparation operation to set a state enabling an image forming operation independently from a request to start image formation, determines, as an operation mode, a color mode for executing preparation operations of all image forming units corresponding to each color of developer, or a monochrome mode for executing a preparation operation of only an image forming unit corresponding to a single color of developer in accordance with warning information indicating a state of the image forming apparatus, and executing a preparation operation in the determined operation mode.

### BACKGROUND OF THE INVENTION

1. Field of the Invention

The present invention relates to an image forming apparatus that executes a warm-up operation, and a method of controlling the same.

2. Description of the Related Art

In the present image forming apparatuses, a warm-up operation is performed before accepting an image output request, such as at a jam recovery time or a power supply activation time. The warm-up operation is commonly provided for both color image forming and monochrome image forming, and is executed in a color mode to cause operation of image forming units of all colors. For example, Japanese Patent Laid-Open No. 2011-17879 proposes an image forming apparatus that executes a warm-up operation of image forming units provided in accordance with four colors (yellow, cyan, magenta and black), at a time of recovery from a power saving mode or at a time of a power supply activation.

However, there is a problem with the above described conventional technique as recited below. For example in the above described conventional technique, to provide for both color image forming and monochrome image forming, the warm-up operation is necessarily executed in the color mode. Accordingly, if forming a monochrome image is already determined, there is a problem that a wasteful preparation operation is executed, and a time until the image forming is started is delayed.

### SUMMARY OF THE INVENTION

The present invention enables realization of an arrangement in which a mode of a warm-up operation executed in jam recovery or at a time of power supply activation is changed in accordance with a state of an apparatus.

One aspect of the present invention provides an image forming apparatus arranged to execute one of a plurality of preparation operations dependent on the operation mode of the apparatus, comprising: an obtaining unit configured to obtain warning information indicating a state of the image forming apparatus; a determining unit configured to determine, in a case where the obtaining means obtains a warning that the image forming apparatus is to be operated in an operation mode different to that prior to the warning information being obtained, an operation mode of the preparation operation in accordance with the warning information, the operation mode including a color mode for executing preparation operations of a plurality of image forming units corresponding to each color of a plurality of developers, and a monochrome mode for executing a preparation operation of an image forming unit corresponding to a predetermined single color among the plurality of image forming units; and an execution unit configured to execute the preparation operation in the operation mode determined by the determining unit.

Another aspect of the present invention provides a method of controlling an image forming apparatus, the method comprising: obtaining warning information indicating a state of the image forming apparatus; determining, in a case where the image forming apparatus executes a preparation operation to set a state enabling an image forming operation independently from a request to warning image formation, an operation mode of the preparation operation in accordance with the state information, the operation mode including a color mode for executing preparation operations of a plurality of image forming units corresponding to each color of a plurality of developers, and a monochrome mode for executing a preparation operation of an image forming unit corresponding to a predetermined single color among the plurality of image forming units; and executing the preparation operation in the determined operation mode.

Further features of the present invention will be apparent from the following description of exemplary embodiments with reference to the attached drawings.

### BRIEF DESCRIPTION OF THE DRAWINGS

FIG. 1 is a cross-sectional view of an image forming apparatus.

FIG. 2 is a block diagram of an image forming apparatus.

FIG. 3 is a flowchart for a warm-up operation upon a YMC motor failure according to a first embodiment.

FIG. 4 is a flowchart for a warm-up operation upon YMC out-of-toner according to a first embodiment.

FIG. 5A and FIG. 5B are views for explaining sheet conveyance jam detection according to a second embodiment.

FIG. 6 is a cross-sectional view at a time of general jam detection according to the second embodiment.

FIG. 7 is a cross-sectional view at a time of jam detection according to the second embodiment.

FIG. 8 is an operation unit screen for jam detection according to the second embodiment.

FIG. 9 is an operation unit screen for jam processing according to the second embodiment.

FIG. 10 is a flowchart for the jam processing according to the second embodiment.

FIG. 11 is a flowchart for jam recovery processing according to the second embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

<Configuration of Image Forming Apparatus>

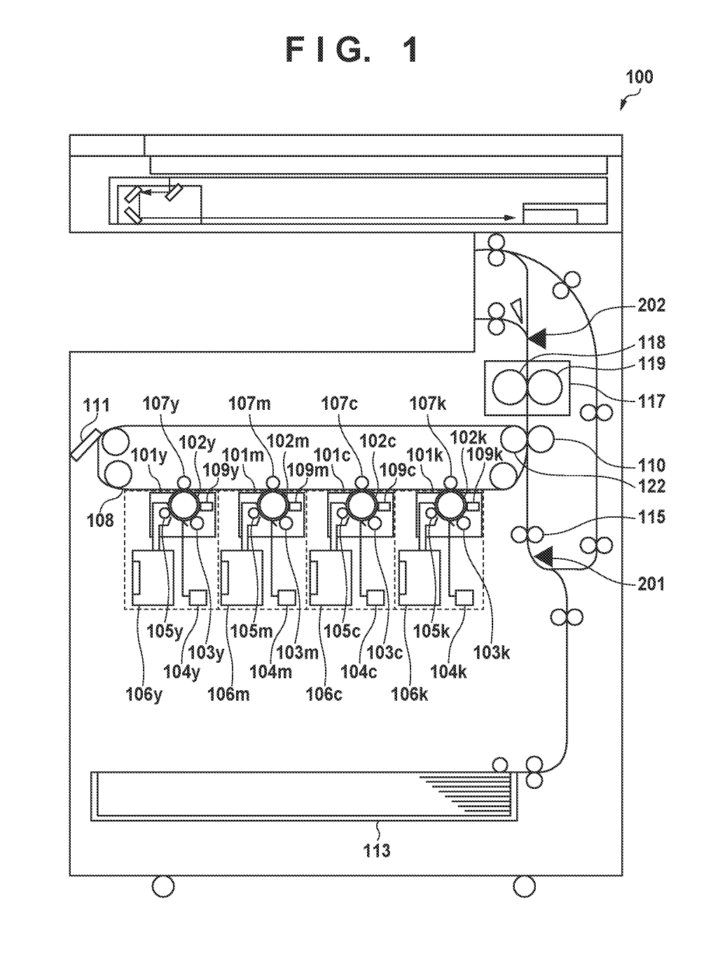

Firstly, referring to FIG. 1, explanation is given for a configuration of an image forming apparatus according to the present invention. An image forming apparatus 100 is provided with processing units 101y, 101m, 101c, 101k arranged in an approximately horizontal straight line at fixed intervals. The processing units 101y, 101m, 101c, 101k respectively form toner images of yellow (y), magenta (m), cyan (c), and black (k) developer. The toner images formed by the processing units 101y, 101m, 101c, 101k are primary transferred to an abutting intermediate transfer belt 108. Toner images of each color overlaid on the intermediate transfer belt 108 are conveyed, and on a nip at which a driving roller 122 and a secondary transfer roller 110 are abutting, are transferred onto a sheet synchronized by a later-described registration roller 115. Each of the processing units 101y, 101m, 101c, 101k is provided with a photosensitive drum 102, a charging roller 103, a laser exposure unit 104, a developing unit 105, a toner container 106, and an auxiliary charging brush 109. In FIG. 1, the symbols y, m, c, and k, corresponding to each color, are added to the end of reference numerals.

Furthermore, the image forming apparatus 100 is provided with primary transfer rollers 107y, 107m, 107c, and 107k, the intermediate transfer belt 108, the secondary transfer roller 110, a transfer cleaning device 111, a feed cassette 113, the registration roller 115, a fixing apparatus 117, the driving roller 122, a pre-registration conveyance sensor, and a conveyance sensor 202. The fixing apparatus 117 is provided with a fixing roller 118 and a pressure roller 119. Operation of each component is described later.

<Control Configuration>

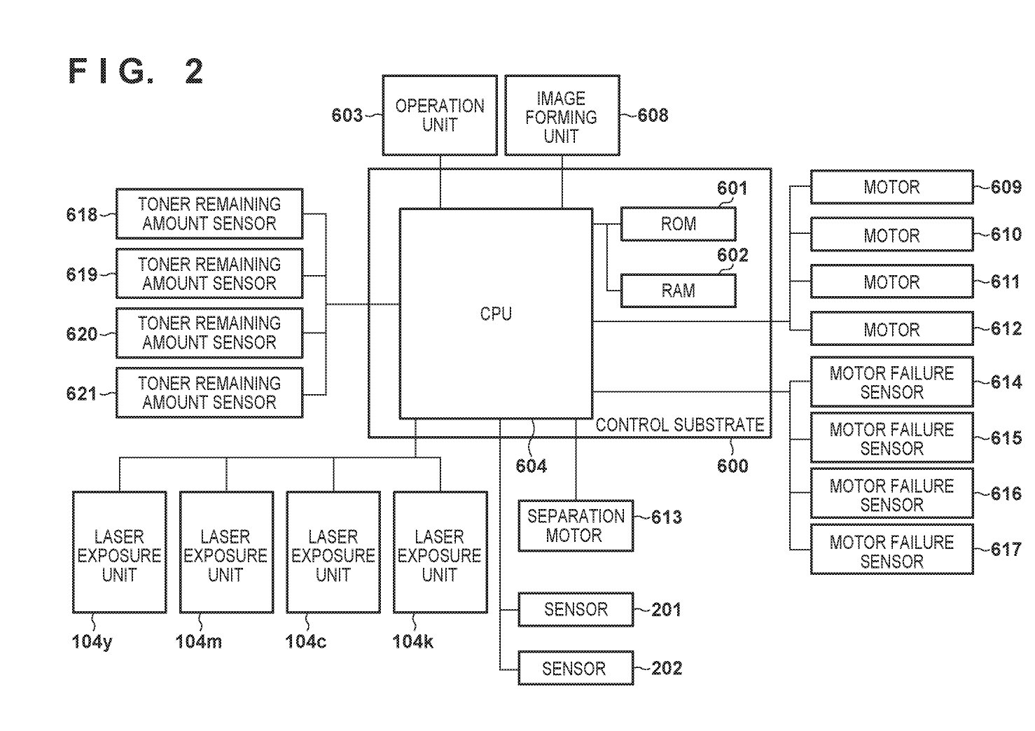

Next, referring to FIG. 2, explanation is given for a configuration regarding control of the image forming apparatus 100 according to the present invention. As a control configuration, the image forming apparatus 100 is provided with a control substrate 600, an operation unit 603, an image forming unit 608, a separation motor 613, various other motors 609 to 612, and various sensors 614 to 621, 201 and 202. The control substrate 600 is comprised of a CPU 604 that performs basic control of the image forming apparatus 100, a RAM 602 that functions as a work area of control programs, and a ROM 601 in which control programs are stored.

The operation unit 603 is provided with hardware keys that accept key input, and a touch panel capable of displaying control information. Upon being instructed to print from the operation unit 603, the CPU 604 controls the image forming unit 608, the motors 609 to 612, and the separation motor 613 in accordance with a program stored in the ROM 601.

The motor 612 is a motor that drives the photosensitive drum 102k and the developing unit 105k, and similarly to the motor 612, the motors 609 to 611 are motors that respectively drive the photosensitive drums 102y, 102m, and 102c and the developing units 105y, 105m, 105c. In addition, motor failure sensors 614, 615, 616, and 617 are sensors that detect failure of a motor, and respectively detect motor failure in correspondence with the motors 609, 610, 611, and 612. In addition, toner remaining amount sensors 618, 619, 620, and 621 are sensors that detect the presence/absence of the toner in toner containers, and each respectively detects the presence/absence of toner in correspondence with the toner containers 106y, 106m, 106c, and 106k. The separation motor 613 is a motor that controls abutting and separation between the intermediate transfer belt 108 and the processing units 101y, 101m, 101c, 101k.

<Image Forming Operation>

Next, FIG. 1 and FIG. 2 are used to explain a basic image forming operation. Upon accepting an image forming start signal for forming a monochrome image, the CPU 604 drives the separation motor 613 and causes the intermediate transfer belt 108 to abut the processing unit 101k. Here, the photosensitive drum 102k of the developing unit 105k, which is rotationally driven at a predetermined process speed, and charged to a negative polarity. The laser exposure unit 104k irradiates from a laser light emitting unit an image signal input from an external unit, and forms an electrostatic latent image on the photosensitive drum 102k.

A developing bias of the same polarity as the charging polarity (negative polarity) of the photosensitive drum 102k is applied to the developing unit 105k, which causes black toner to adhere to the electrostatic latent image formed on the photosensitive drum 102k, forming a visible image of the toner image. In a primary transfer, a primary transfer bias (an opposite polarity (positive polarity) to the toner) is applied to the primary transfer roller 107k. At that time, in a state in which the primary transfer roller 107k is pressed to the photosensitive drum 102k via the intermediate transfer belt 108, the toner image on the photosensitive drum 102k is transferred to the intermediate transfer belt 108, which is driven.

The toner image on the intermediate transfer belt 108 is conveyed to a secondary transfer unit between the driving roller 122 and the secondary transfer roller 110. Matching timing at which a leading end of the toner image moves to the secondary transfer unit, a recording medium such as a sheet fed by the feed cassette 113 passes through a conveying path formed approximately vertically, and is conveyed to the secondary transfer unit by the registration roller 115. The toner image is transferred all at once, to the recording medium conveyed to the secondary transfer unit, by the secondary transfer roller 110 to which the secondary transfer bias (opposite polarity (positive polarity) to the toner) has been applied. After transferring to the recording medium, residual toner remaining on the intermediate transfer belt 108 is scraped off by the transfer cleaning device 111, and is conveyed and recovered as recovered toner.

The recording medium on which the toner image has been formed is conveyed to the fixing apparatus 117 which is positioned downstream from the secondary transfer unit. The toner image formed on the recording medium is heated and pressurized by a fixing nip section between the fixing roller 118 and the pressure roller 119, and thermally fixed on a surface of the recording medium. In accordance with the above operations, a sequence of image forming terminates.

Upon accepting an image forming start signal for forming a color image, the CPU 604 drives the separation motor 613 and causes the intermediate transfer belt 108 to abut the processing units 101y, 101m, 101c, and 101k. Thereafter, image forming operations for each color that are similar to those for a monochrome image are performed.

### First Embodiment

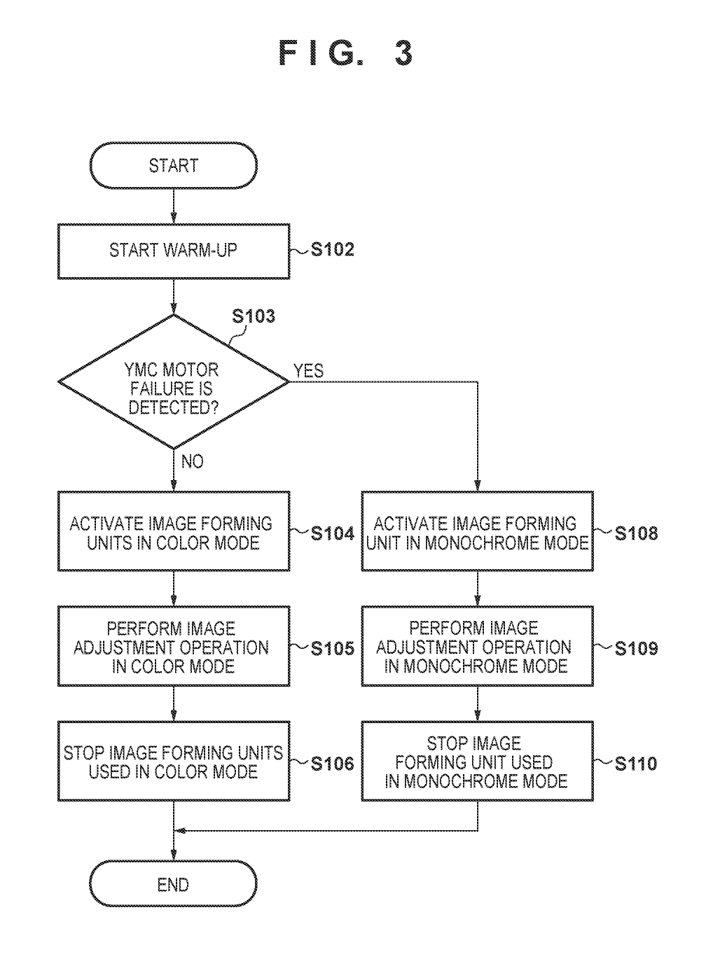

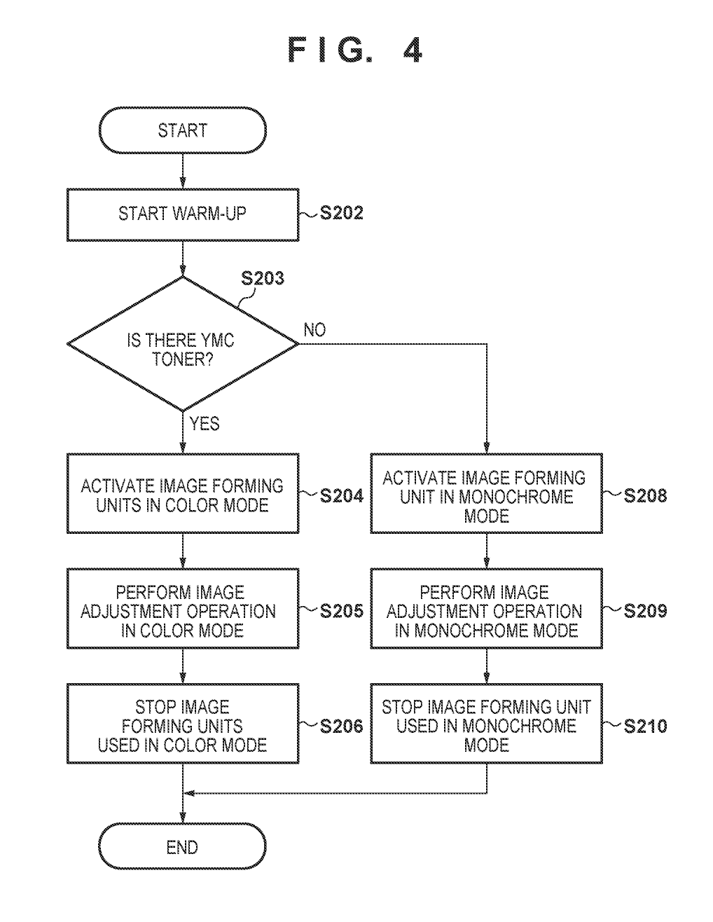

Below, explanation is given for control according to a first embodiment of the present invention, with reference to FIG. 3 and FIG. 4. Firstly, explanation is given for a warm-up operation (a preparation operation) performed at a time of a power ON of the image forming apparatus (at a time of power supply activation) or at a time of a recovery from a sleep (a power saving mode), and prior to the above-described image forming operation.

As the warm-up operation when power ON is performed, the image forming apparatus 100 drives the separation motor 613, and causes the intermediate transfer belt 108 to abut the processing units 101y, 101m, 101c, and 101k. Furthermore, the image forming apparatus 100 causes the developing units 105y, 105m, 105c, and 105k and the photosensitive drums 102y, 102m, 102c, and 102k to be driven rotationally at a predetermined process speed. When preparation by which the image forming is possible is ready, image adjustment operation of the image forming unit is performed.

In image adjustment operation, to correct the density of the output image, the image forming apparatus 100 firstly forms a patch for density adjustment on the intermediate transfer belt 108, reads a density output value of the patch in accordance with a sensor, and performs a density table correction so that image forming at a target density is possible. Next, to correct color misregistration of each color in the output image, the image forming apparatus 100 forms a patch for color misregistration adjustment of each color on the intermediate transfer belt 108, reads the color misregistration between each color of the patch by a sensor, and performs adjustment so that the image forming timing of each color becomes as desired.

When this image adjustment operation terminates, the image forming apparatus 100 causes rotation of the developing units 105y, 105m, 105c, and 105k and the photosensitive drums 102y, 102m, 102c, and 102k to stop, and the warm-up operation terminates. Note that, in the warm-up operation, preparation of the fixing apparatus 117 may be performed. In this way, the image forming apparatus 100 activates in the color mode, which is an operation mode that causes the processing units 101y, 101m, 101c, and 101k of all colors to operate, and performs image adjustment operation such as density adjustment or color misregistration adjustment. These warm-up operations are performed independently from a request to start image formation. Thereby, it is possible for the image forming apparatus 100 to provide image forming operations for both color image outputting and monochrome image outputting, based on a following request to start image formation. In addition, after receiving the start request for image formation, a preparation operation for image formation, such as preparation of a laser exposure unit or heating of a fixing apparatus, is performed as necessary.

The image forming apparatus 100 can detect a component failure of any of the plurality of motors 609, 610, and 611 by a sensor (motor failure sensors 614, 615, and 616). Also, the image forming apparatus 100 can detect the existence or absence of toner in the plurality of toner containers 106y, 106m, and 106c by sensors (the toner remaining amount sensors 618, 619, and 620). If a component failure or out-of-toner is detected for the processing units 101y, 101m, and 101c, because forming of a color image cannot be performed, the image forming apparatus 100 performs a function restriction that only permits an image forming start signal for forming a monochrome image. Regarding detail of the function restriction, explanation is given later using FIG. 3 and FIG. 4.

In a warm-up operation in a case of performing the above described function restriction, the image forming apparatus 100 drives the separation motor 613, causes the intermediate transfer belt 108 to abut the processing unit 101k, and causes the developing unit 105k and the photosensitive drum 102k to be driven rotationally at a predetermined process speed. When preparation that enables image formation is complete, the image forming apparatus 100 performs image adjustment operation of only the density adjustment of black (K), and when the image adjustment operation terminates, causes the rotation of the developing unit 105k and the photosensitive drum 102k to stop, and then the warm-up operation terminates. In other words, the image forming apparatus 100 does not cause the processing units 101y, 101m, and 101c of yellow (Y), magenta (M), and cyan (C) to operate, and is activated in the monochrome mode as an operation mode that causes the processing unit 101k of black (K) to operate, and performs density adjustment of black (K). However, color misregistration correction for each color is not executed. Note that, in the present embodiment, black is described as an example as a color that corresponds to the monochrome mode. However, the present invention is not limited to this, and a predetermined single color other than black may be the color corresponding to the monochrome mode. Configuration is taken so that in such a case, if operation is impossible for an image forming unit corresponding to a color other than the predetermined single color, a warm-up operation is executed for only the image forming unit corresponding to the single color.

With such a configuration, in a case of an apparatus state (state information) in which image forming of a color image is not possible due to a component failure, being out-of-toner for yellow (Y), magenta (M), or cyan (C), or the like, an image forming operation is provided for only a monochrome image. Thereby, it is possible to reduce not just downtime generated by performing unnecessary image adjustment operation, but also downtime generated by driving and stopping an unnecessary processing unit. Note that, here a warm-up operation at a time of a power ON was described, but similar processing is also performed for a warm-up operation performed at a time of recovery from sleep. In addition, in the present embodiment, an operation at a time of motor failure or out-of-toner was described, but a case of a state in which an image forming unit of a color of one of yellow, magenta, or cyan cannot perform image formation that is due to some other cause is similar.

<Processing Procedure>

With reference to FIG. 3, explanation is given of a processing procedure of a warm-up operation in a case of a function restriction. Processing explained below is realized by the CPU 604 reading the control program, which is stored in the ROM 601, into the RAM 602 and executing it.

When the power supply of the image forming apparatus 100 is turned ON, in step S102 the CPU 604 starts the above described warm-up operation. Next, in step S103, the CPU 604 determines whether a motor failure of any of the motor failure sensor 614 of yellow, the motor failure sensor 615 of magenta, and the motor failure sensor 616 of cyan is detected. For example, the CPU 604 may confirm the output signal (state information) of each sensor, and determine whether a failure has occurred based on the signal value. In other words, if the state information indicates a failure, as a state in which an image forming unit of a corresponding color cannot operate, it is determined to execute the warm-up operation in the monochrome mode. If a failure is not detected, it is determined that all image forming units can operate, and so it is determined to execute the warm-up operation in the color mode. Upon determining to execute the warm-up operation in the color mode, the CPU 604 advances the processing to step S104, and activates the image forming units in the color mode, i.e. performs the warm-up operation. When preparation of the image forming units is completed the CPU 604 advances the processing to step S105, performs image adjustment operation of the image forming units in the color mode, and when the image adjustment operation terminates, in step S106 stops the image forming units used in the color mode, and the warm-up operation terminates.

Meanwhile, if a failure was detected in step S103 the CPU 604 advances the processing to step S108, performs activation of the image forming unit in the monochrome mode, and in step S109 performs image adjustment operation of the image forming unit in the monochrome mode. In other words, if image forming in the color mode is not possible due to a failure, instead of a warm-up operation in the color mode, a warm-up operation in the monochrome mode is executed. Thereby, time required for a warm-up operation is reduced, without a wasteful warm-up operation being executed. When the image adjustment operation in the monochrome mode terminates, the CPU 604 advances the processing to step S110, the image forming unit used in the monochrome mode is stopped, and the warm-up operation terminates.

Note that, in the warm-up operation in the monochrome mode, activation and image adjustment operation of the image forming unit associated with black is performed. In the monochrome mode, as image adjustment operation that adjusts the density, the CPU 604 performs image formation of only a black (K) patch, reads the patch by a sensor, and performs density correction. However, for image adjustment operation that adjusts color misregistration, if image formation of a color image is not possible due to a function restriction, because there is no need to adjust the color misregistration, the color misregistration adjustment mode itself is not executed and image formation of the black (K) patch is also not performed.

In addition, in the present embodiment, explanation was given for switching the warm-up operation in the monochrome mode and the color mode. However, the present invention is not limited to this, and, for example, in a case such as that corresponding to two-color printing in which an image forming apparatus prints by using toner of two colors, a mode that activates an image forming unit of a color other than that for an image forming unit that has a failure may be provided. Furthermore, if the motor failure sensor 617 detects a failure of the motor 612 for black (K), because image formation of a monochrome image and not just a color image is not possible, the image forming apparatus may control so as to prohibit execution of the warm-up operation.

Next, referring to FIG. 4, explanation is given of a processing procedure of a warm-up operation when there is no toner for any of yellow (Y), magenta (M), or cyan (C). Processing explained below is realized by the CPU 604 reading the control program, which is stored in the ROM 601, into the RAM 602 and executing it.

When the power supply of the image forming apparatus 100 is turned ON, in step S202 the CPU 604 starts the above described warm-up operation. Next, in step S203, the CPU 604 determines whether there is toner in each of the toner containers 106y, 106m, and 106c by the toner remaining amount sensor 618 of yellow, the toner remaining amount sensor 619 of magenta and the toner remaining amount sensor 620 of cyan. If it is determined that toner for yellow (Y), magenta (M), and cyan (C) exists, the processing proceeds to step S204, and the CPU 604 activates the image forming unit in the color mode, that is performs the warm-up operation. Then, when preparation of the image forming units is completed the CPU 604 advances the processing to step S205, performs image adjustment operation of the image forming units in the color mode, and when the image adjustment operation terminates, in step S206 stops the image forming units used in the color mode, and the warm-up operation terminates.

However, if it is determined in step S203 that there is no toner in any one of yellow (Y), magenta (M) or cyan (C), the CPU 604 advances the processing to step S208, and the CPU 604 activates the image forming unit in the monochrome mode, and performs image adjustment operation of the image forming unit in the monochrome mode. In other words, if image forming in the color mode is not possible due to being out-of-toner, instead of a warm-up operation in the color mode, the image forming apparatus executes a warm-up operation in the monochrome mode. Thereby, time required for a warm-up operation is reduced, without a wasteful warm-up operation being executed. When the image adjustment operation in the monochrome mode terminates, the CPU 604 advances the processing to step S210, the image forming unit used in the monochrome mode is stopped, and the warm-up operation terminates.

In the image adjustment operation that adjusts the density, the image forming apparatus performs image formation for only a black (K) patch, the patch is read by a sensor, and density correction is performed. However, in the image adjustment operation that adjusts the color misregistration, if there is no toner for any one of yellow (Y), magenta (M), or cyan (C), and image forming of a color image cannot be performed, a need to adjust color misregistration disappears. Accordingly, in the warm-up operation in the monochrome mode, the color misregistration adjustment mode itself is not performed, in addition to not performing image formation of the black (K) patch. Note that, if it is determined by the toner remaining amount sensor 621 for black (K) that there is no toner, because image formation for not just a color image but also for a monochrome image is not possible, the image forming apparatus may control so as to prohibit execution of the warm-up operation.

In the above described explanation, the mode of the warm-up operation is determined based on a motor failure or a remaining amount of toner in an image forming unit, but configuration may be taken to determine the mode of the warm-up operation based on detection of another cause that obstructs color image forming.

As explained above, in the image forming apparatus according to the present embodiment, if image forming in the color mode is not possible due to some cause—in other words if any of the yellow, magenta, or cyan image forming units cannot be used—the image forming apparatus executes the warm-up operation in the monochrome mode. In the warm-up operation in the monochrome mode, the image forming apparatus executes activation and adjustment of only the image forming unit corresponding to black, and does not execute activation or adjustment and color misregistration adjustment of an image forming unit of another color. With this, time taken by the warm-up operation is shortened.

### Second Embodiment

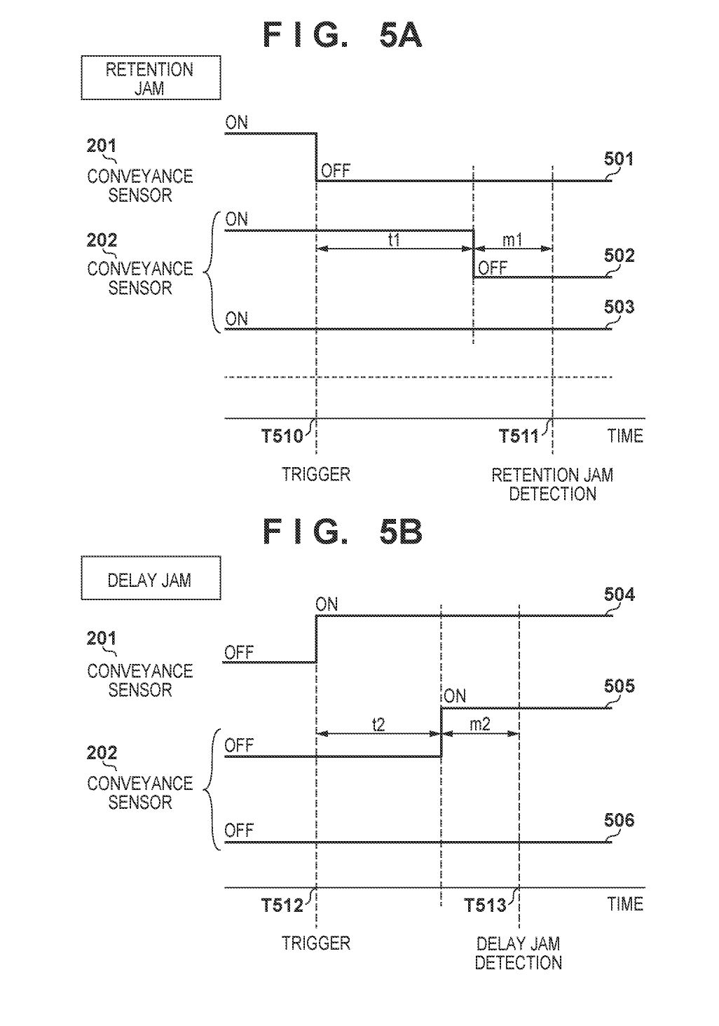

Below, explanation is given for control according to a second embodiment of the present invention, with reference to FIG. 5A through FIG. 12. Explanation is given in the present embodiment of a warm-up operation in a recovery process performed after resolving a jam, if a jam of a sheet has occurred while executing image formation. Firstly, with reference to FIG. 5A and FIG. 5B, explanation is given for jam detection during sheet conveyance. FIG. 5A and FIG. 5B are sequence diagrams for illustrating timing of detection results of the conveyance sensor 201, which is arranged upstream of the registration roller 115, and the conveyance sensor 202, which is arranged downstream of the fixing apparatus 117. FIG. 5A illustrates retention of a sheet (hereinafter, referred to as a retention jam) in the conveyance sensor 202. FIG. 5B illustrates delay of a sheet (hereinafter, referred to as a delay jam) in the conveyance sensor 202.

Firstly, with reference to FIG. 5A, explanation is given for detection of a retention jam of a sheet by the conveyance sensor 202. Retention jam detection starts, triggered by the CPU 604 detecting passage of a sheet rear end by the conveyance sensor 201 during sheet conveyance. In other words, as illustrated by a signal waveform 501, a timing T510 at which the conveyance sensor 201 is changed from ON to OFF is a timing of the trigger of retention jam detection. From a distance between sensors, the conveying speed of the sheet and the timing of the trigger T510, a sheet rear end transit time t1 of the conveyance sensor 202 is calculated. At this point, conveyance efficiency may decrease due to abrasion of the conveyance roller or the configuration of the conveying mechanism itself. Assuming a time in which this is considered is a conveyance margin m1, it can be predicted that time t1+m1 will be needed for the sheet rear end to pass the conveyance sensor 202 after passing the conveyance sensor 201. If a jam does not occur, as illustrated by reference numeral 502, from when the conveyance sensor 201 detects the sheet rear end, it is possible for the conveyance sensor 202 to detect the sheet rear end until the time t1+m1 elapses. Meanwhile, as illustrated by a signal waveform 503, if the conveyance sensor 202 cannot detect passage of the sheet rear end even by the timing T511 at which time t1+m1 has elapsed since the conveyance sensor 201 detected the sheet rear end, a retention jam is determined.

Next, with reference to FIG. 5B, explanation is given for detection of a delay jam of a sheet by the conveyance sensor 202. Delay jam detection starts, triggered by detection of passage of a sheet leading end by the conveyance sensor 201 during sheet conveyance. In other words, as illustrated by a signal waveform 504, a timing T512 at which the conveyance sensor 201 is changed from OFF to ON is a timing of the trigger of a delay jam detection. From a distance between sensors, the conveying speed of the sheet and the timing of the trigger T512, a sheet leading end arrival time t2 of the conveyance sensor 202 can be calculated. At this point, conveyance efficiency may decrease due to abrasion of the conveyance roller or the configuration of the conveying mechanism itself. Assuming a time in which this is considered is a conveyance margin m2, it can be predicted that time t2+m2 will be taken for the sheet leading end to arrive at the conveyance sensor 202 from the conveyance sensor 201. If a jam does not occur, as illustrated by a signal waveform 505, from when the conveyance sensor 201 detects the sheet leading end, it is possible for the conveyance sensor 202 to detect the sheet leading end until the time t2+m2 elapses. Meanwhile, as illustrated by a signal waveform 506, if the conveyance sensor 202 cannot detect arrival of the sheet leading end even by the timing T513 at which time t2+m2 has elapsed since the conveyance sensor 201 detected the sheet leading end, a delay jam is determined.

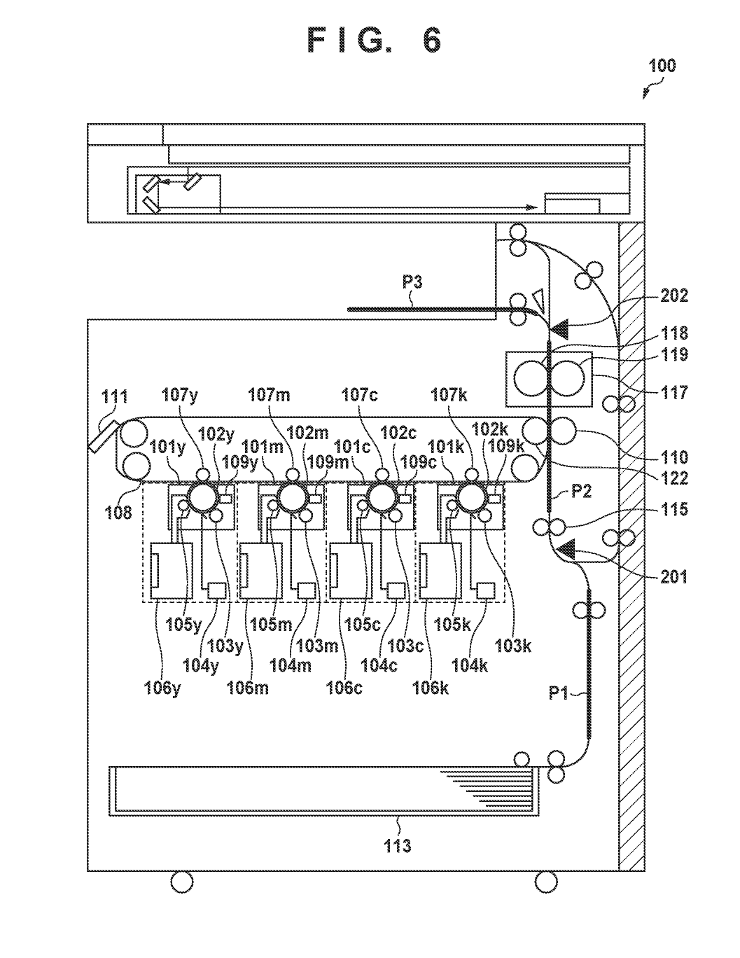

Note that the above-described jam detection determination is one example, and the present invention is not limited to the above-described jam detection method. If the above-described delay jam or retention jam is detected, assuming that a sheet P2 illustrated in FIG. 6 is the causal sheet of the jam, the image forming apparatus determines that the sheet P2 and a sheet P1, for which sheet feeding has been completed and which is present upstream of the sheet P2, are remaining sheets in the jam, and stops corresponding conveyance. The image forming apparatus conveys the sheet P3, which is downstream of the causal sheet P2 of the jam, as normal, and discharges the sheet P3 from the apparatus. When processing (normal discharge from the apparatus, conveyance stoppage for remaining sheets in the jam) for all sheets present on the conveyance path has terminated, the image forming apparatus prompts a user to perform jam processing. Here, the CPU 604 stores, in the RAM 602, whether the causal sheet of the jam is a sheet conveyed in the color mode or a sheet conveyed in the monochrome mode.

<Jam Processing>

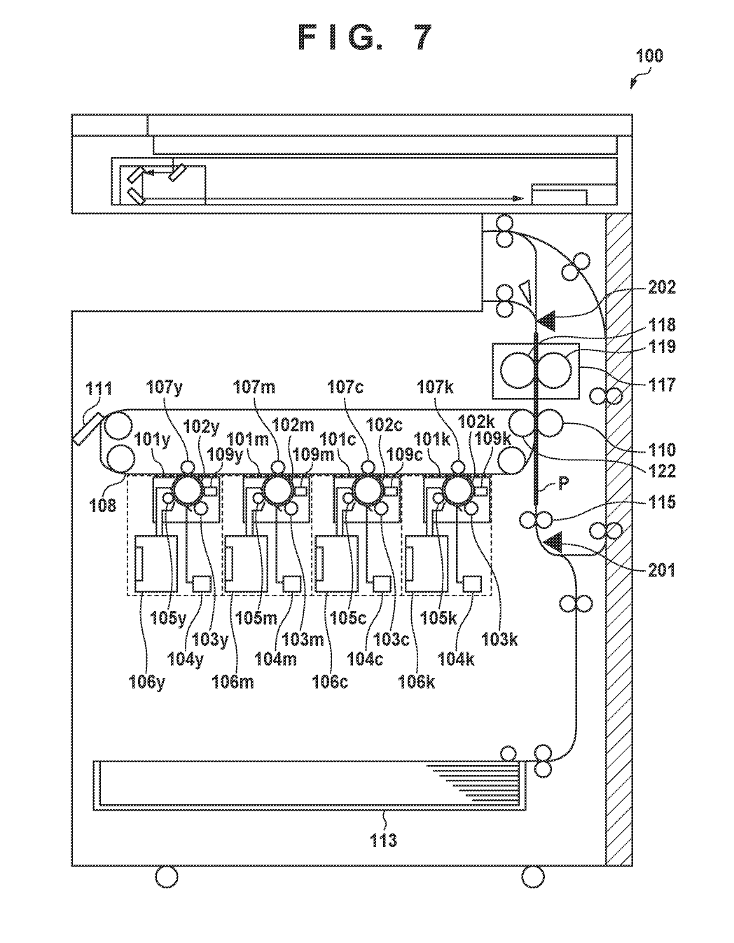

Next, with reference to FIG. 7 through FIG. 10, explanation is given for jam processing. Here, explanation is given for jam processing when a delay jam is generated by the conveyance sensor 202.

FIG. 7 illustrates a position of a remaining sheet P in the apparatus when a delay jam has occurred. Here, the position of a remaining sheet differs in accordance with job content (sheet size, single-sided job, double-sided job) or a sheet conveyance interval (a distance), and one example thereof is illustrated. In FIG. 7, the remaining sheet P is positioned on a conveyance path between the conveyance sensor 201 and the conveyance sensor 202.

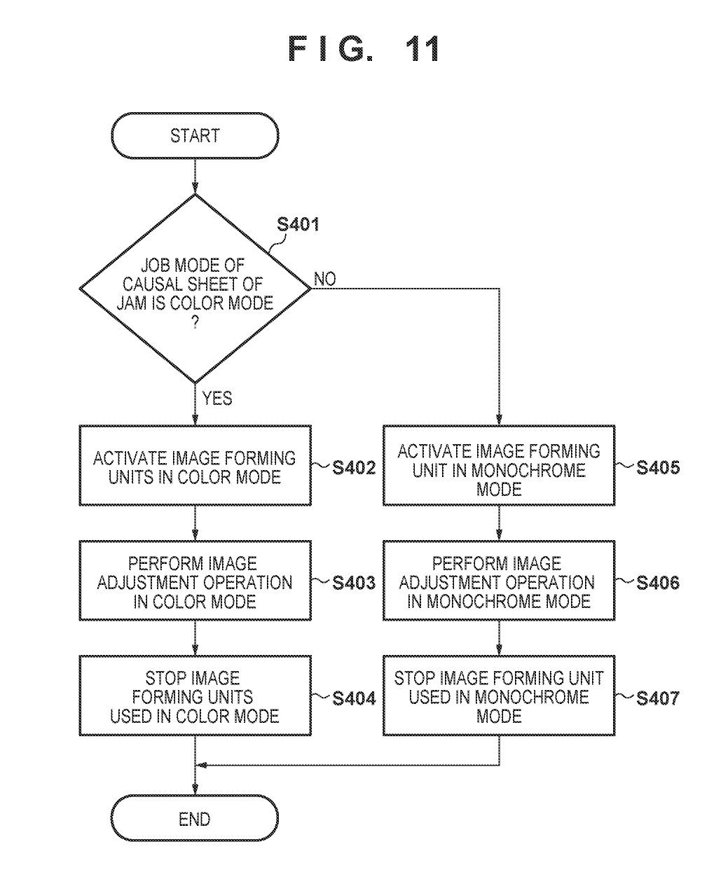

FIG. 10 illustrates a processing procedure for jam processing in the present embodiment. Processing explained below is realized by the CPU 604 reading the control program, which is stored in the ROM 601, into the RAM 602 and executing it.

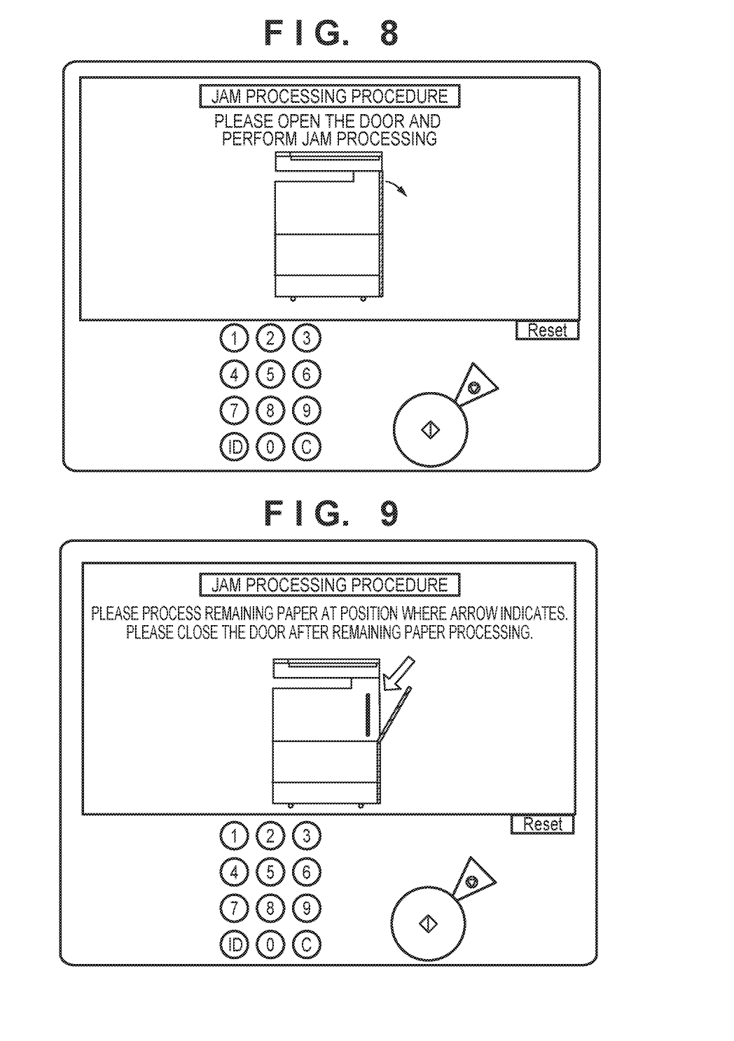

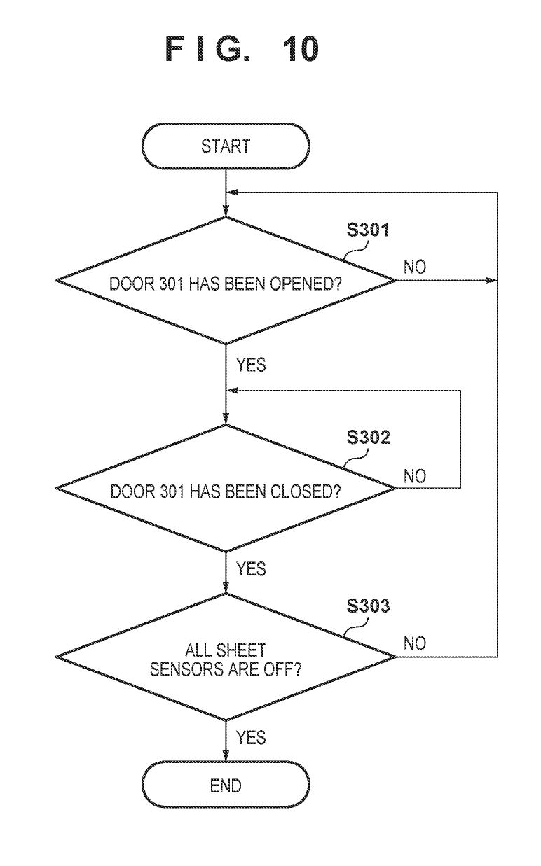

After jam detection, to notify a user of a position of the remaining sheet P, the CPU 604 displays, as illustrated in FIG. 8, a screen to prompt opening of a door on the operation unit 603. Thereafter, in step S301 the CPU 604 determines whether a door 301 has been opened in accordance with a door open/close sensor. If it is determined that the door 301 has been opened, the CPU 604 displays, as illustrated in FIG. 9, a screen prompting the user to perform jam processing in the apparatus, and processing proceeds to step S302.

In step S302, after the sheet is removed by the user, the CPU 604 determines whether the door 301 has been closed, and when the door is closed, the processing proceeds to step S303, and whether all conveyance sensors in the apparatus are OFF is determined. Note that the conveyance sensor being off is a state in which the conveyance sensor is not detecting a sheet. If it is determined that any of the conveyance sensors are not OFF and a remaining sheet is present, the CPU 604 once again displays an animation for door opening and closing illustrated in FIG. 9, and prompts a user to perform processing of the remaining sheet. However, if all of the conveyance sensors are OFF, the CPU 604 determines that a remaining sheet is not present, causes jam processing to terminate, and transitions to jam recovery processing.

<Recovery Processing>

Next, with reference to FIG. 11, explanation is given for jam recovery processing. Processing explained below is realized by the CPU 604 reading the control program, which is stored in the ROM 601, into the RAM 602 and executing it.

In step S401 the CPU 604 determines whether a job mode of the causal sheet of the jam stored in the RAM 602 at the time of jam detection, as previously described, is the color mode. If the job mode stored in the RAM 602 is the color mode, because the first sheet of jam recovery is executed in the color mode, the CPU 604 performs activation of the image forming unit in the color mode in step S402. This activation processing includes cleaning of the photosensitive drum, or the like. When preparation of the image forming unit is complete, the CPU 604 performs image adjustment operation of the image forming unit in the color mode in step S403, and when the image adjustment operation terminates, the CPU 604 in step S404 stops the image forming unit used in the color mode, and the recovery process terminates. Here, because the image adjustment operation executed has similar details to those of step S105 and step S205 of the above-described first embodiment, explanation thereof is omitted.

Meanwhile, if the job mode stored in the RAM 602 is the monochrome mode, because execution is performed in the monochrome mode for the first sheet of jam recovery, the CPU 604 performs activation of the image forming unit in the monochrome mode in step S405. Next, in step S406, the CPU 604 performs the image adjustment operation of the image forming unit in the monochrome mode, and when the image adjustment operation terminates, in step S407 stops the image forming unit used in the monochrome mode, and the recovery process terminates. Here, because the image adjustment operation executed has similar details to those of step S109 and step S209 of the above-described first embodiment, explanation thereof is omitted.

As explained above, the image forming apparatus according to the present embodiment stores whether a job executed at jam occurrence time is in the color mode or the monochrome mode at the jam occurrence time. Furthermore, in the recovery process (warm-up operation) after the jammed sheet is removed, control is performed in the mode that was stored. Thus, by executing a preparation operation (warm-up operation) at jam recovery time in accordance with the job mode immediately prior to a jam occurrence, a wasteful color preparation operation is not executed at a recovery process time in the case of a monochrome job, and it is possible to shorten recovery time.

### Other Embodiments

If a control substrate of the image forming apparatus 100 is configured to be divided into a job controller that performs control of image forming jobs and an engine controller that performs control of an image forming engine, control as below may be performed.

Upon receiving a request to start image formation from the job controller, the engine controller executes image formation. In the above described jam recovery, the engine controller starts the warm-up operation from before receiving the request to start the image forming for recovery from the job controller. At this point, the engine controller determines what sheet is the causal sheet of the jam, and determines the operation mode of the warm-up operation in accordance with whether image formation was performed in the color mode or the monochrome mode. After termination of the warm-up operation and upon receiving, from the job controller, the start request for image formation for recovery, the engine controller executes image forming in accordance with the image formation request. Note that if the start request for image formation is received during a warm-up operation, the engine controller executes image formation after termination of the warm-up operation.

The present application discloses an image forming apparatus, comprising: obtaining unit operable to warning information indicating a state of the image forming apparatus; execution unit operable to execute an image forming preparation operation according to either a first operation mode or a second operation mode in the case that the image forming apparatus is set to an image forming state as a result of a command which is different to an image forming command; determining unit operable to determine based on the obtained warning information the operation mode in which the image forming apparatus is to perform the image forming preparation operation; and wherein the first operation mode is a mode for executing preparation operations for a plurality of image forming units corresponding to each color of a plurality of developer colors, and the second operation mode is a monochrome mode for executing preparation operations for an image forming unit corresponding to a single color from among the plurality of developer colors.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-010681 filed on Jan. 22, 2015, which is hereby incorporated by reference herein in its entirety.

What is claimed is:

1. An image forming apparatus arranged to execute one of a plurality of preparation operations dependent on the operation mode of the apparatus, comprising:
an obtaining unit configured to obtain warning information indicating a state of the image forming apparatus;
a determining unit configured to determine, in a case where the obtaining means obtains a warning that the image forming apparatus is to be operated in an operation mode different to that prior to the warning information being obtained, an operation mode of the preparation operation in accordance with the warning information, the operation mode including a color mode for executing preparation operations of a plurality of image forming units corresponding to each color of a plurality of developers, and a monochrome mode for executing a preparation operation of an image forming unit corresponding to a predetermined single color among the plurality of image forming units; and
an execution unit configured to execute the preparation operation in the operation mode determined by the determining unit.

2. The image forming apparatus according to claim 1, wherein the warning information includes information indicating whether or not the image forming units corresponding to respective colors of the plurality of developers are in an operable state.

3. The image forming apparatus according to claim 2, wherein
the obtaining unit comprises a sensor for detecting a failure of each of the plurality image forming units, and
the determining unit,
if the warning information indicates that at least one of the plurality of image forming units corresponding to other than the predetermined single color has a failure, determines the monochrome mode as the operation mode of the preparation operation, and,
if the warning information indicates that all of the plurality of image forming units respectively corresponding to all of the developers are operable, determines the color mode as the operation mode of the preparation operation.

4. The image forming apparatus according to claim 3, wherein if the warning information indicates that the image forming unit corresponding the predetermined single color has a failure, the execution unit prohibits execution of the preparation operation.

5. The image forming apparatus according to claim 3, wherein the sensor for detecting the failure of the plurality image forming units is a sensor for detecting a failure of a motor for driving each image forming unit.

6. The image forming apparatus according to claim 2, wherein
the obtaining unit comprises a sensor for detecting existence or absence of developer of each color, and
the determining unit,
if the warning information indicates absence of at least one developer other than the predetermined single color, determines the monochrome mode as the operation mode of the preparation operation, and,
if the warning information indicates existence of the plurality of developers, determines the color mode as the operation mode of the preparation operation.

7. The image forming apparatus according to claim 6, wherein
if the warning information indicates absence of developer of the predetermined single color,
the execution unit prohibits execution of the preparation operation.

8. The image forming apparatus according to claim 1, wherein the preparation operation is performed upon a power supply activation of the image forming apparatus and upon a recovery from a power saving mode.

9. The image forming apparatus according to claim 1, further comprising
a detection unit configured to detect a jam of a sheet during execution of image forming, and
a storing unit configured to store, when a jam is detected, an operation mode of a corresponding image forming, the operation mode including a color image forming mode for image forming using a plurality of developers, and a monochrome image forming mode for image forming without using a developer other than the predetermined single color, wherein
the determining unit further
determines an operation mode of the preparation operation performed upon recovery from the detected jam based on the operation mode stored in the storing unit.

10. The image forming apparatus according to claim 9, wherein
the determining unit, if the operation mode stored in the storing unit is the color image forming mode, determines the color mode as the operation mode of the preparation operation, and if the operation mode stored in the storing unit is the monochrome image forming mode, determines the monochrome mode as the operation mode of the preparation operation.

11. The image forming apparatus according to claim 1, wherein
for the preparation operation in the color mode, activation, image density adjustment and color misregistration adjustment of each image forming unit is executed, and
for the preparation operation in the monochrome mode, activation and image density adjustment of the image forming unit of the predetermined single color is executed.

12. The image forming apparatus according to claim 1, wherein the predetermined single color is black.

13. A method of controlling an image forming apparatus, the method comprising:
obtaining warning information indicating a state of the image forming apparatus;
determining, in a case where the image forming apparatus executes a preparation operation to set a state enabling an image forming operation independently from a request to warning image formation, an operation mode of the preparation operation in accordance with the state information, the operation mode including a color mode for executing preparation operations of a plurality of image forming units corresponding to each color of a plurality of developers, and a monochrome mode for executing a preparation operation of an image forming unit corresponding to a predetermined single color among the plurality of image forming units; and
executing the preparation operation in the determined operation mode.
